(19) United States
(12) Patent Application Publication
(10) Pub. No.: US 2011/0174122 A1
(43) Pub. Date: Jul. 21, 2011

(54) Ring saw cutting machine

(75) Inventors: Hans-Joerg Braun, Hagen (DE); Klaus-Dieter Martin, Wetter (DE)

(73) Assignee: REIKA GMBH & CO. KG, Hagen (DE)

(21) Appl. No.: 12/800,270

(22) Filed: May 12, 2010

(30) Foreign Application Priority Data
Jan. 20, 2010 (EP) 10000503.2

(51) Int. Cl. B23D 45/08; B23Q 15/007

(52) U.S. Cl. 83/13; 83/360; 83/522.12

(57) ABSTRACT

A ring saw including a housing with a whirling assembly, on which a holder for a saw blade with inner teeth connected with a drive is rotatably mounted. A control unit controls the assembly. A vibration meter is disposed on the housing. The whirling assembly has a rotational position transducer for detecting the saw blade's rotational position. An evaluation unit, connected with the vibration meter and the rotational position transducer, is set up so that a vibration progression per saw blade tooth is determined on the basis of the vibration meter and rotational position transducer measurement data. The evaluation unit is connected with the control unit of the whirling assembly, which is set up so that the saw blade penetrates into the work piece with a region of low measured vibration amplitude during the penetration process. A method for controlling a saw blade of a ring saw is also provided.

### CROSS REFERENCE TO RELATED APPLICATIONS

Applicants claim priority under 35 U.S.C. §119 of European Application No. 10000503.2 filed on Jan. 20, 2010.

### BACKGROUND OF THE INVENTION

1. Field of the Invention

The present invention relates to a whirling cutting machine including a housing with a whirling assembly, on which a holder for a saw blade with inner teeth connected with a drive is disposed, mounted so as to rotate, and which assembly can be controlled by way of a control unit. The invention furthermore relates to a method for control of a whirling cutting machine.

2. The Prior Art

The whirling method is a chip-cutting method in which the tool circles around the work piece in the manner of a spiral. The cutting depth is produced using one or more blades that circulate at a high cutting speed in a single work cycle. In this connection, the inner mantle surface formed by the cutting tool rolls on the cylindrical outer mantle surface of the work piece to be machined. This movement process is superimposed on the constantly circulating movement of the cutting tool.

The whirling method, known, for example, from EP 0 490 328 B1, has the advantage that a plurality of cutting tools, particularly cutting steels, can be disposed next to one another and stand in engagement with the work piece at the same time over a larger segment region. In whirling cutting, a whirling saw tool with teeth lying on the inside—hereinafter subsumed in the term “saw blade”—is used in this connection. The cutting teeth of the saw blade can penetrate into the work piece tangentially. Because of the whirling method, the effective penetration radius of the saw blade has to cover only the wall thickness of the work piece. If this work piece is a solid material, the saw blade has to penetrate only to the center point of the solid material because the other half of the work piece is cut off by the circulating movement of the saw blade. Such whirling cutting devices are called “ring saw” hereinafter.

The use of the whirling method for cutting work pieces in pipe and rod form has proven itself; in particular, in this connection, the machining times can be clearly reduced. The non-uniform stress on the cost-intensive saw blades, however, proves to be problematic because the blades have to be completely replaced even if saw teeth have become worn only in certain regions.

### SUMMARY OF THE INVENTION

It is an object of the present invention to provide a remedy for these disadvantages. The invention is based on the task of creating a ring saw that allows more uniform stress on the saw blade. According to the invention, this task is accomplished by a ring saw wherein a vibration meter is disposed on the housing, the whirling assembly has a rotational position transducer for detecting the rotational position of the saw blade, and an evaluation unit is connected with the vibration meter and the rotational position transducer and set up in such a manner than the saw blade is determined on the basis of the measurement data of the vibration meter and rotational position transducer. The evaluation unit is connected with the control unit of the whirling assembly, which is set up in such a manner that the saw blade penetrates into the work piece with a region of low measured vibration amplitude during the penetration process.

With the invention, a ring saw is provided that allows uniform stress on the saw blade. It has been shown that significant stress on the saw blade occurs during penetration into the work piece. By detecting the vibration progression of the individual teeth of the saw blade and penetration of the saw blade at a saw blade region having a lower measured vibration amplitude, the saw blade is immersed into the work piece at its least worn region, in each instance. In this way, targeted, uniform stress on the saw blade during the penetration process is brought about.

In a further embodiment, the saw blade can be positioned during every penetration process, by way of the control unit, at the time of introduction into the work piece, so that penetration takes place with the tooth of the saw blade that has the lowest vibration amplitude. In this way, a stress on the saw blade directed at the individual tooth of the saw blade is brought about during penetration into the work piece.

In an embodiment of the invention, the evaluation unit is connected with a database in which the vibration behavior of the individual saw teeth over time can be stored. In this way, the wear progression of the individual saw teeth can be followed up.

Preferably, turning on the whirling assembly during the penetration process, using the control unit, takes place based on the vibration behavior history of the individual saw teeth filed in the database. In this way, a detailed wear picture of the saw blade can be taken into consideration, and thus uniform wear of the saw blade is brought about.

In another embodiment of the invention, the evaluation unit is connected with an alarm device and set up so that when a vibration limit value is exceeded at a defined number of saw teeth, a warning signal is triggered. In this way, timely replacement of the saw blade when worn is made possible, thereby achieving high work quality.

In another embodiment, the evaluation unit is connected with an output unit by way of which the vibration behavior of the individual saw teeth of a saw blade over time can be called up. In this way, improved quality assurance of the work process is made possible.

In a further embodiment, the evaluation unit is connected with an input unit by way of which a replacement of the saw blade can be stored in memory. In this way, assignment of a vibration behavior filed in the database to a specific saw blade is made possible.

In an embodiment of the invention, the saw blade is provided with a clear identifier that can be read out using a disposed reader unit connected with the evaluation unit. In this way, assignment of vibration behaviors determined to individual saw blades is made possible, thereby also making possible statements concerning the wear behavior of refurbished saw blades. As a result, a statement concerning, for example, changed useful lifetimes of refurbished saw blades is also possible.

In another embodiment of the invention, a tool replacement system is disposed, which is connected with the evaluation unit, whereby if a vibration limit value of a defined number of saw teeth is exceeded, a tool replacement is triggered. In this way, automatic tool replacement as a function of the wear of the saw blades used is made possible. As a result, high quality can be provided for a great number of cutting processes, as is required, for example, in the case of production islands without personnel.

The invention is furthermore based on the task of providing a method for controlling a ring saw that allows uniform stress on the saw blade. According to the invention, this task is accomplished by a method whereby the vibration of the housing of the ring saw as well as the rotational position of the saw blade of the ring saw are continuously detected. The vibration behavior of each saw tooth or defined region of the saw blade, in each instance, is determined from the detected vibration and rotational position data. The saw blade is positioned during every penetration process of the saw blade into a work piece, in such a manner that the penetration takes place with the saw tooth or defined region of the saw blade that demonstrate the lowest vibration amplitude.

With the invention, a method for controlling a ring saw is created, which allows uniform stress on the saw blade. Using the continuous detection of the vibrations of the housing of the ring saw, as well as the rotational position of the saw blade of the ring saw, the vibration behavior of each saw tooth or of a defined region of the saw blade can be determined. The vibration behavior of the individual saw teeth or saw tooth regions during the penetration process of the saw blade into a work piece is taken into consideration in such a manner that the penetration takes place with the saw tooth or the defined saw tooth region of the saw blade that demonstrates the lowest vibration amplitude. In this way, uniform stress on the saw blade with regard to the penetration processes, in each instance, is brought about over multiple cutting processes.

In a further development of the invention, the housing vibrations are monitored with regard to a defined maximal limit amplitude, whereby if the limit amplitude is reached, a phase shift of the drive of the ring saw is undertaken. In this way, a shift in the vibration stress on the saw blade is brought about, and this shift in turn leads to more uniform stress on the saw blade.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic rear view of a ring saw;

FIG. 2 is a spatial representation of the device of FIG. 1; and

FIG. 3 is a schematic representation of the evaluation and control array of the ring saw of FIG. 1.

### DETAILED DESCRIPTION OF PREFERRED EMBODIMENTS

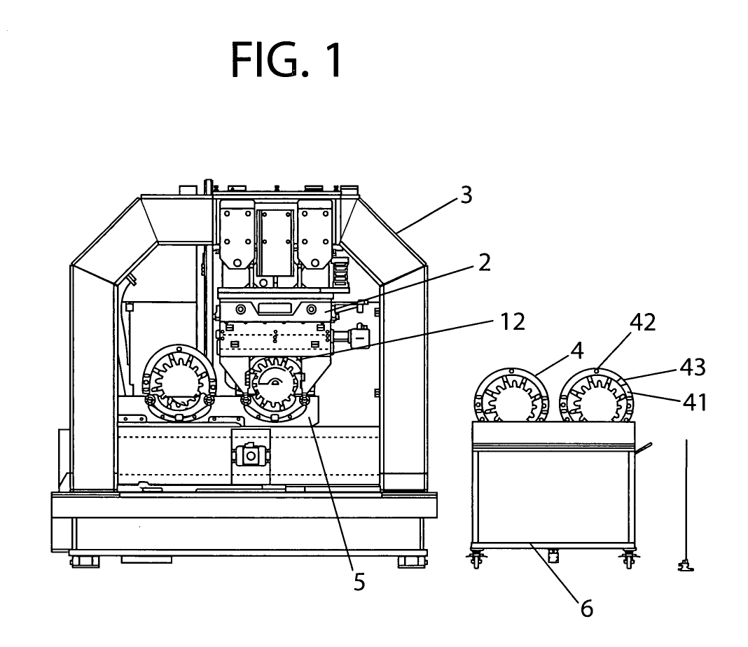

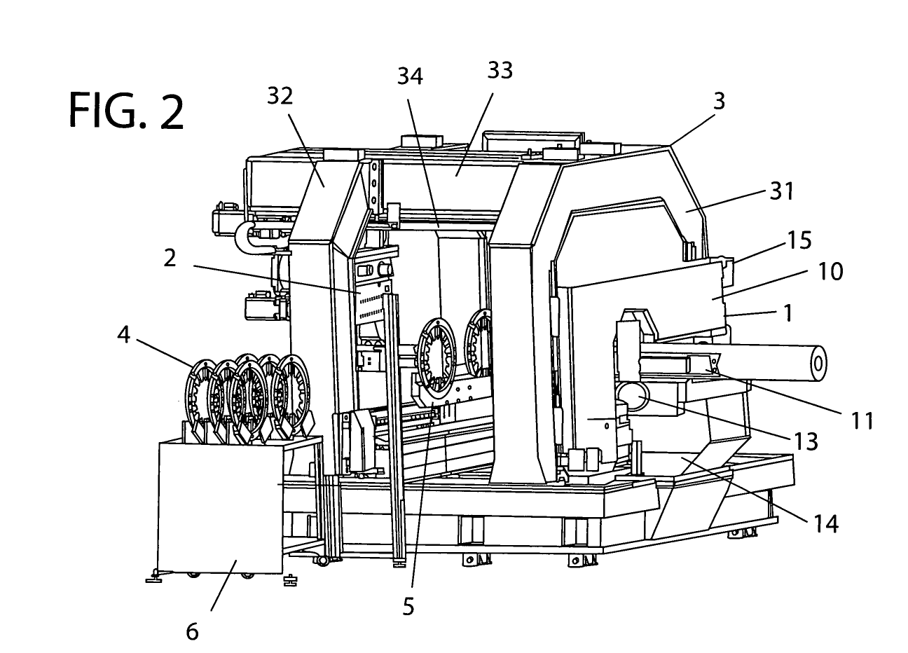

FIGS. 1-3 show an exemplary embodiment of a ring saw that includes a whirling assembly 1 disposed in a housing 10, with its work piece feed 11 and a pickup 2, which are disposed in a frame system 3. In this connection, frame system 3 is essentially formed from two portals 31, 32 disposed parallel to one another, which are connected with one another, on the head side, by way of a connection beam 33. In this connection, whirling assembly 1 is attached to the assembly portal 31, and the support portal 32 serves as the support of connection beam 33. A rail 34 on which pickup 2 is disposed in displaceable manner is attached to connection beam 33.

Whirling assembly 1 comprises a tool holder 12 for holding a saw blade 4, which is connected with a drive—not shown. The drive has a rotational position transducer 13 that allows precise detection as well as positioning of tool holder 12, and thus also of saw blade 4 held by it. Tool holder 12 is connected with a cross-table assembly, by way of which it can be moved on defined curves by way of a control 14. Furthermore, a vibration sensor or meter 15 to detect the vibrations of whirling assembly 1 is disposed on housing 10 of whirling assembly 1.

Tool holder 12 is configured essentially in funnel shape. This formation has an advantageous effect on the removal of chips. On the circumference of its ring opening, a contact flange for contact of a saw blade 4, with precise fit, is disposed in tool holder 12. For a defined position of saw blade 4 in tool holder 12, the contact flange is provided with an indexing pin—not shown—that can be introduced into an indexing bore 42 made in blade carrier ring 41 of saw blade 4. In the region of tool holder 12, a radio frequency identification (RFID) antenna 16 is disposed, for reading out the tool data filed in the RFID chip 43 disposed on blade carrier ring 41 of saw blade 4. (Alternatively, mechanical coding of the tool data can also be disposed on saw blade 4; these data can be read out by way of a corresponding tactile or optical device.)

Rotational position transducer 13, vibration meter 15, as well as RFID antenna 16 are connected with an evaluation unit 7, which, in turn, is connected with a database 71, in which the vibration behavior of the individual saw teeth of a saw blade 4 over time, as determined by evaluation unit 7, can be stored. Furthermore, evaluation unit 7 is connected with an input unit 72, by way of which replacement of a saw blade 4 can be documented, and with an output unit 73, by way of which a vibration history of a saw blade 4 can be displayed. Furthermore, evaluation unit 7 is coupled with a tool replacement system 5 that is integrated into the ring saw in the exemplary embodiment, and is manually equipped by means of a supply cart 6.

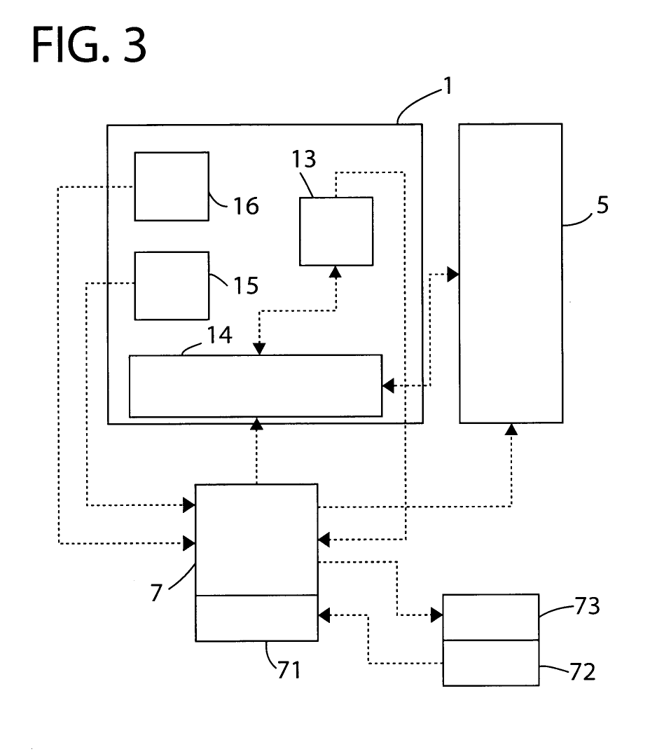

The method for achieving uniform stress on a saw blade, implemented in the ring saw, is schematically shown in FIG. 3. During operation of the ring saw, the vibrations of whirling assembly 1 are continuously detected by way of vibration meter 15, and passed on to evaluation unit 7. At the same time, continuous detection of the rotational position of saw blade 4 takes place by way of rotational position transducer 13, whose data are also passed on to evaluation unit 7. Identification of saw blade 4 takes place by way of RFID antenna 16, which reads out the data of RFID chip 43 disposed on blade carrier ring 41 of saw blade 4, and passes them on to evaluation unit 7.

By means of evaluation unit 7, on the basis of the measurement data of vibration meter 15 and rotational position transducer 13, the continuous vibration progression per tooth of saw blade 4 is determined, and filed in database 71 over time.

Before the penetration process of the saw blade, evaluation unit 7 of control 14 of whirling assembly 1 transmits the rotational position of saw blade 4, with the saw tooth determined to have the least wear, based on the vibration data filed in database 71.

In this connection, the wear of each saw tooth is determined on the basis of the vibration amplitude of the saw tooth, in each instance, whereby a higher vibration amplitude is equated with greater wear. Control unit 14 is set up in such a manner that saw blade 4 penetrates into the work piece, during the penetration process into a work piece, with the region of least wear of saw blade 4, as transmitted by evaluation unit 7.

Although only at least one embodiment of the present invention has been shown and described, it is to be understood that many changes and modifications may be made thereunto without departing from the spirit and scope of the invention.

What is claimed is:

1. A ring saw comprising:
(a) a saw blade having a plurality of inner teeth;
(b) a housing comprising a whirling assembly, said whirling assembly comprising a control unit and a rotational position transducer for detecting a rotational position of the saw blade;
(c) a saw blade holder for the saw blade rotatably mounted to the whirling assembly;
(d) a drive connected with the saw blade holder;
(e) a vibration meter disposed on the housing; and
(f) an evaluation unit connected with the vibration meter, the rotational position transducer, and the control unit, said evaluation unit being set up so that a vibration progression per tooth of the saw blade is determined based on measurement data from the vibration meter and the rotational position transducer, said control unit being set up so that the saw blade penetrates into a work piece during a penetration process with a region of low measured vibration amplitude.

2. The ring saw according to claim 1, wherein during the penetration process, the saw blade is positioned by way of the control unit at the time of penetration into the work piece in such a manner that penetration takes place with a tooth of the saw blade that demonstrates a lowest vibration amplitude.

3. The ring saw according to claim 1, further comprising a database connected with the evaluation unit, the database storing vibration behavior history comprising vibration behavior determined for individual saw teeth over time.

4. The ring saw according to claim 3, wherein the control unit activates the whirling assembly during the penetration process based on the vibration behavior history of the individual saw teeth filed in the database.

5. The ring saw according to claim 3, further comprising an alarm device connected with the evaluation unit, the alarm device being set up in such a manner that when a vibration limit value is exceeded at a defined number of saw teeth, a warning signal is triggered.

6. The ring saw according to claim 3, further comprising an output unit connected with the evaluation unit, the output unit enabling call up of the vibration behavior of the individual saw teeth over time.

7. The ring saw according to claim 3, further comprising an input unit connected with the evaluation unit, the input unit enabling storage in memory of a replacement of the saw blade.

8. The ring saw according to claim 1, wherein the saw blade is provided with a clear identifier that can be read out using a disposed reader unit connected with the evaluation unit.

9. The ring saw according to claim 5, further comprising a tool replacement system connected with the evaluation unit, the tool replacement system triggering a tool replacement when a vibration limit value of a defined number of saw teeth is exceeded.

10. A method for controlling a saw blade of a ring saw comprising the steps of:
(a) generating vibration and rotational position data by continuously detecting housing vibrations of a housing of the ring saw and rotational positions of the saw blade;
(b) determining a respective vibration behavior of each saw tooth or a defined region of the saw blade from the vibration and rotational position data generated; and
(c) positioning the saw blade during each penetration process of the saw blade into a work piece so that penetration takes place with a saw tooth or defined region of the saw blade demonstrating a lowest vibration amplitude.

11. The method according to claim 10, wherein the vibration behavior of each saw tooth or defined region of the saw blade over time is stored in a database.

12. The method according to claim 10, wherein the housing vibrations are monitored with regard to a defined maximal limit amplitude, wherein when the limit amplitude is reached, a phase shift of a drive of the ring saw is undertaken.
